(19) United States
(12) Patent Application Publication
(10) Pub. No.: US 2017/0197790 A1
(43) Pub. Date: Jul. 13, 2017

(54) CONVEYOR CHAIN

(71) Applicant: REXNORD INDUSTRIES, LLC, Milwaukee, WI (US)

(72) Inventors: Igor B. Zelenovskiy, Mequon, WI (US); Justin Michael Stefanko, Waukesha, WI (US); Philip Michael Gabor, Jackson, WI (US); Kevin Scott Hansen, Grafton, WI (US); Robert E. Mitchell, Milwaukee, WI (US)

(21) Appl. No.: 15/316,445

(22) PCT Filed: Jun. 3, 2015
(86) PCT No.: PCT/US2015/034011

§ 371 Date: Dec. 6, 2016

Related U.S. Application Data
(60) Provisional application No. 62/008,266, filed on Jun. 5, 2014.

(51) Int. Cl. B65G 17/06; B65G 39/20; B65G 17/38

(52) U.S. Cl. CPC B65G 17/065; B65G 17/38; B65G 39/20

(57) ABSTRACT

A conveyor chain including a continuous cord (914) arranged to be driven and to bear a load applied to the conveyor chain, a cord coupler (918) secured to the cord (914), and a module (922) including a top plate (926) and a module coupler (978). The module coupler (978) engages the cord coupler (918) such that the module (922) is secured to the cord (914).

### RELATED APPLICATIONS

This application claims priority to U.S. Provisional Patent Application No. 62/008,266 filed on Jun. 5, 2014, the entire contents of which are incorporated herein by reference.

### BACKGROUND OF THE INVENTION

The present invention relates to conveyor systems. More particularly, the invention relates to table top, or flat top type conveyors for supporting and moving objects.

Current table top chain designs are limited by the strength of molded base links or a fabricated roller base chain. Such table top chains are susceptible to joint wear and elongation during use. Additionally, these systems are often used in an unnatural condition where they are forces through spirals, sideways deflection, or side-bow. These systems also have issues with pin retention in stamped and molded sidebars.

A solution is needed that provides a table top style conveyor that is flexible, eliminated hinge wear, travels easily through dynamic conveyor systems, and is easily scalable for different applications.

### SUMMARY OF THE INVENTION

One embodiment of the present invention provides a conveyor chain including a continuous cord arranged to be driven and to bear a load applied to the conveyor chain, a cord coupler secured to the cord, and a module including a top plate and a module coupler. The module coupler engages the cord coupler such that the module is secured to the cord.

### BRIEF DESCRIPTION OF THE DRAWINGS

FIG. 1 is a schematic representation of a conveyor chain according to the invention.

FIG. 2a is a pictorial view of a conveyor chain according to one embodiment of the invention.

FIG. 2b is an exploded view of the conveyor chain of FIG. 2a.

FIG. 2c is a front view of the conveyor chain of FIG. 2a.

FIG. 2d is a side view of the conveyor chain of FIG. 2a.

FIG. 2e is a rear view of the conveyor chain of FIG. 2a.

FIG. 3a is a pictorial view of a conveyor chain according to another embodiment of the invention.

FIG. 3b is an exploded view of the conveyor chain of FIG. 3a.

FIG. 3c is a front view of the conveyor chain of FIG. 3a.

FIG. 3d is a side view of the conveyor chain of FIG. 3a.

FIG. 3e is a section view of the conveyor chain of FIG. 3a taken along line 3e-3e of FIG. 3d.

FIG. 4a is a pictorial view of a conveyor chain according to another embodiment of the invention.

FIG. 4b is an exploded view of the conveyor chain of FIG. 4a.

FIG. 4c is a front view of the conveyor chain of FIG. 4a.

FIG. 4d is a side view of the conveyor chain of FIG. 4a.

FIG. 4e is a section view of the conveyor chain of FIG. 4a taken along line 4e-4e of FIG. 4d.

FIG. 5 is a pictorial view of a conveyor chain according to another embodiment of the invention.

FIG. 6 is a pictorial view of the conveyor chain of FIG. 5.

FIG. 7 is a pictorial view of a conveyor chain according to another embodiment of the invention.

FIG. 8 is a pictorial view of a conveyor chain according to another embodiment of the invention.

FIG. 9 is a pictorial view of a conveyor chain according to another embodiment of the invention.

FIG. 10 is a pictorial view of a conveyor chain according to another embodiment of the invention.

FIG. 11 is a pictorial view of a conveyor chain according to another embodiment of the invention.

FIG. 12 is a pictorial view of a conveyor chain according to another embodiment of the invention.

FIG. 13 is an exploded view of the conveyor chain of FIG. 12.

FIG. 14 is a pictorial view of a conveyor chain according to another embodiment of the invention.

FIG. 15 is a pictorial view of a conveyor chain according to another embodiment of the invention.

FIG. 16 is a pictorial view of a conveyor chain according to another embodiment of the invention.

FIG. 17 is a pictorial view of a conveyor chain according to another embodiment of the invention.

FIG. 18 is a pictorial view of a conveyor chain according to another embodiment of the invention.

FIG. 19 is a pictorial view of a conveyor chain according to another embodiment of the invention.

FIG. 20 is a pictorial view of a conveyor chain according to another embodiment of the invention.

### DETAILED DESCRIPTION OF PREFERRED EMBODIMENTS

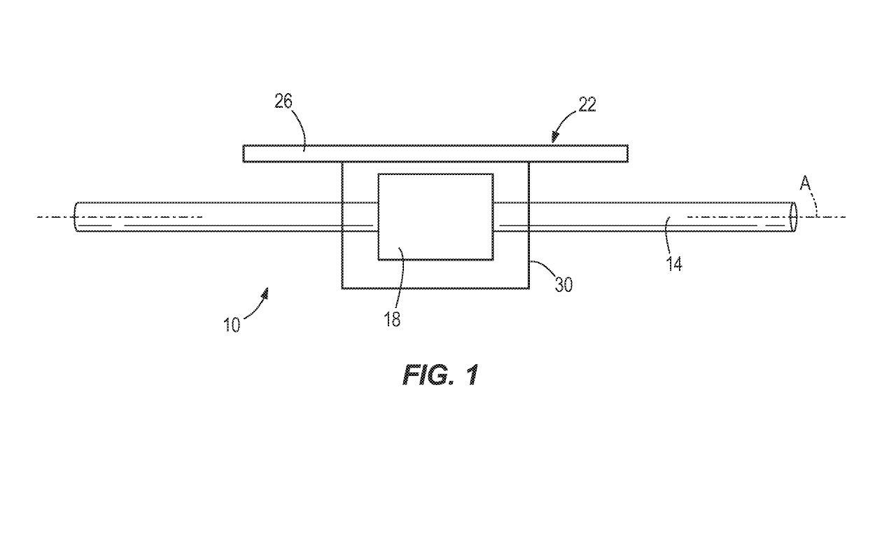

FIG. 1 shows a conveyor chain 10 that includes a cord 14, a cord coupler 18, and a module 22. The cord coupler 18 is coupled to the cord 14, and the module 22 is coupled to the cord coupler 18 such that the cord 14 bears the load applied by a conveyor system and the module 22 is pulled along with the cord 14 while supporting an object. Description of the conveyor chain 10 will be directed to a single cord coupler 18 and a single module 22 positioned on the cord 14. Those skilled in the art will recognize that a plurality of module couplers 18 and modules 22 would be arranged along the cord 14 to form a functions conveyor chain 10.

The cord 14 extends along an axis A and may be formed of wire, synthetic rope, or another suitable cordage, as desired. The cord is arranged to be driven by a conveyor system such that the cord is the load carrying element of the conveyor chain 10. That is to say, the load of the conveyor system is not directed through the module 22. The cord 14 is configured to provide flexibility in substantially three-hundred-sixty degrees (360°) about the axis A. The flexibility of the cord 14 overcomes many of the short fallings of current systems. Namely, the cord 14 allows for easy travel of the conveyor chain 10 around the conveyor system while eliminating hinge wear and strain issues caused by flexing. Further, the cord 14 is easily scalable to account for the required load that will be required of the conveyor chain 10. The cord 14 may be scaled independent of the module 22 such that the conveyor chain 10 as a whole is more adaptable than current systems.

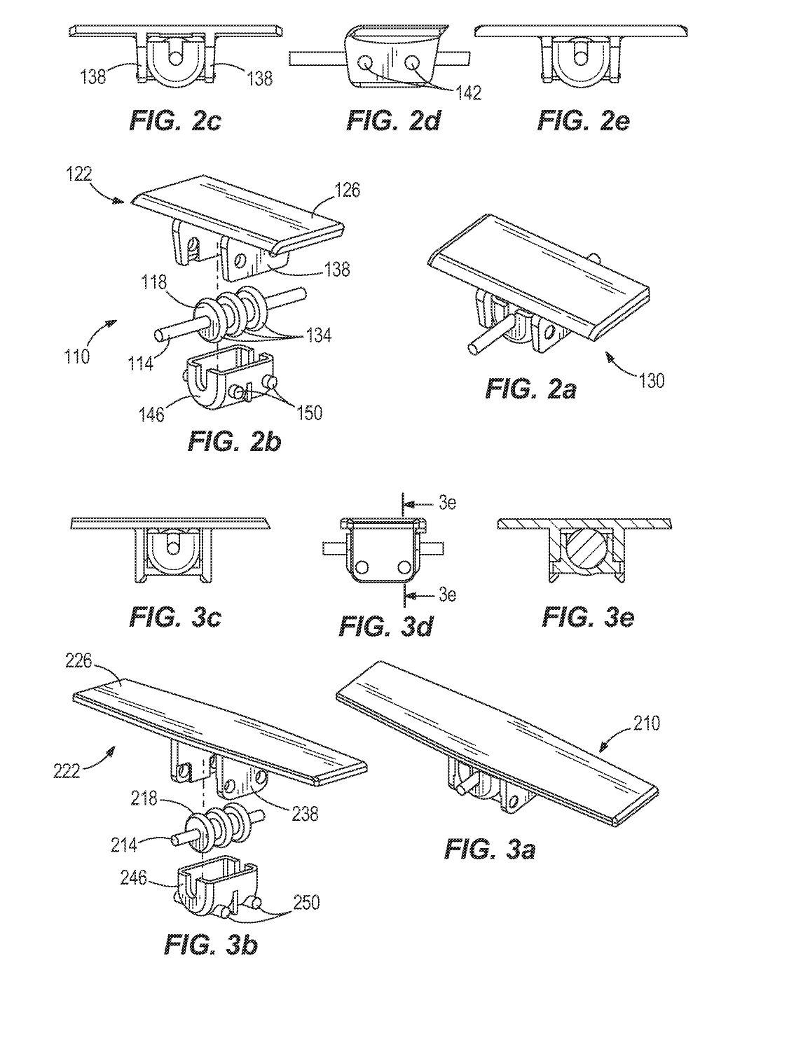

The cord coupler 18 is rigidly coupled to the cord 14. In some embodiments, the cord coupler 18 is molded to the cord 14, formed with the cord 14, entwined with the cord 14, or fastened to the cord 14. The manner of attachment of the cord coupler 18 to the cord 14 is not limiting beyond the feature of the cord coupler 18 being rigidly coupled with the cord 14 for movement along the axis A with the cord 14 around the conveyor system. As will be discussed below with reference to FIGS. 2-20, the cord coupler 18 may take many different forms, shapes, and attributes. No matter the specific design of the cord coupler 18, the purpose is to transfer force from the load carrying cord 14 to the module 22 such that the module 22 is moved along the conveyor system with the movement of the cord 14 and the cord coupler 18.

The module 22 includes a support surface in the form of a top plate 26 and a module coupler 30 coupled to the top plate 26 and arranged to engage the cord coupler 18. As discussed below with reference to FIGS. 2-20, the top plate 26 and the module coupler 30 may have many different arrangements designed to perform specific tasks. Generally, the top plate 26 is intended to support an object for conveyance along the conveyor system and the module coupler 30 is intended to transfer force from the cord coupler 18 to the module 22 such that the entire module 22 moves along with the cord 14 during operation of the conveyor chain 10. In this way, the module 22 serves to support the object, while the cord 14 bears the load of conveying the module 22 and the object along a conveyor path. Again, as mentioned above, this allows the conveyor chain 10 to be scaled to a specific task, provide flexibility in conveyance path, and avoid wear to individual modules. An added benefit of the modules 22 is that the module coupler 30 allows each individual module 22 to be removed from the cord 14 without affecting adjacent modules 22. In some embodiments, the module coupler 30 may be eliminated and the top plate 26 may be directly connected to the cord coupler 18.

The following description will include brief descriptions of each of the embodiments illustrated in FIGS. 2-20. Each embodiment will be identified with a different one-hundred series number set. for example, FIG. 2 will include a conveyor chain 110, a cord 114, a cord coupler 118, and a module 122. FIG. 3 will refer to a conveyor chain 210, et cetera. More embodiments than are shown herein are contemplated within the scope of the invention.

FIGS. 2a-e show a conveyor chain 110 wherein the cord coupler 118 defines three toroidal projections 134 that extend from the cord 114. The module 122 includes two arms 138 that project from the top plate 126 and include apertures 142. The module coupler 130 includes a detachable clamp 146 sized to receive the cord coupler 118 and allow the cord 114 to pass therethrough. The clamp 146 defines projections 150 sized to engage the apertures 142 of the arms 138. FIG. 2a shows the conveyor chain 110 assembled such that an object may be supported by the top plate 126, and the cord 114 acts as the load bearing member transferring force to the top plate trough the cord coupler 118 and the module coupler 130.

FIGS. 3a-e show a conveyor chain 210 similar to the conveyor chain 110 but with a different shaped top plate 226 and a different shaped clamp 246.

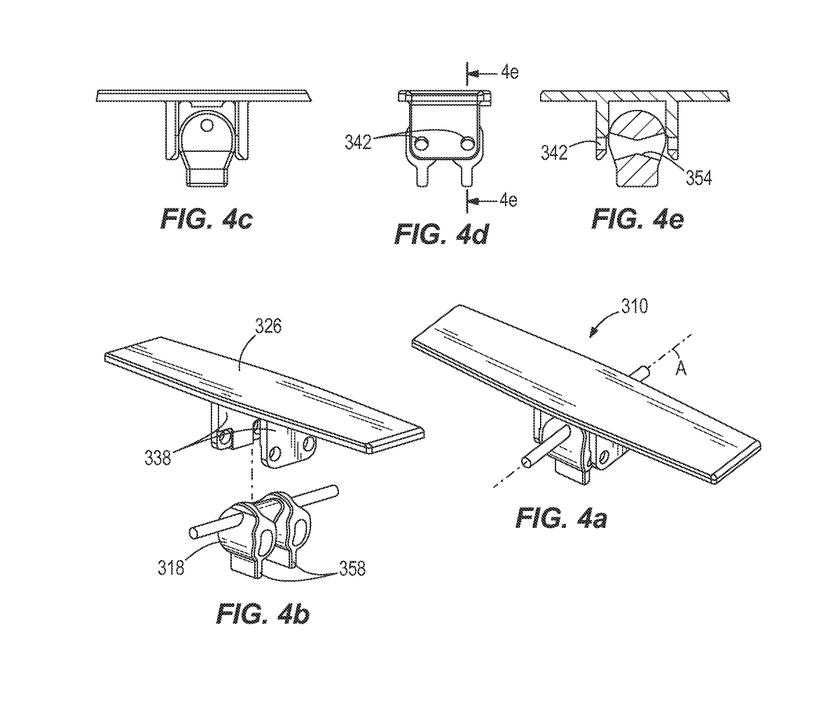

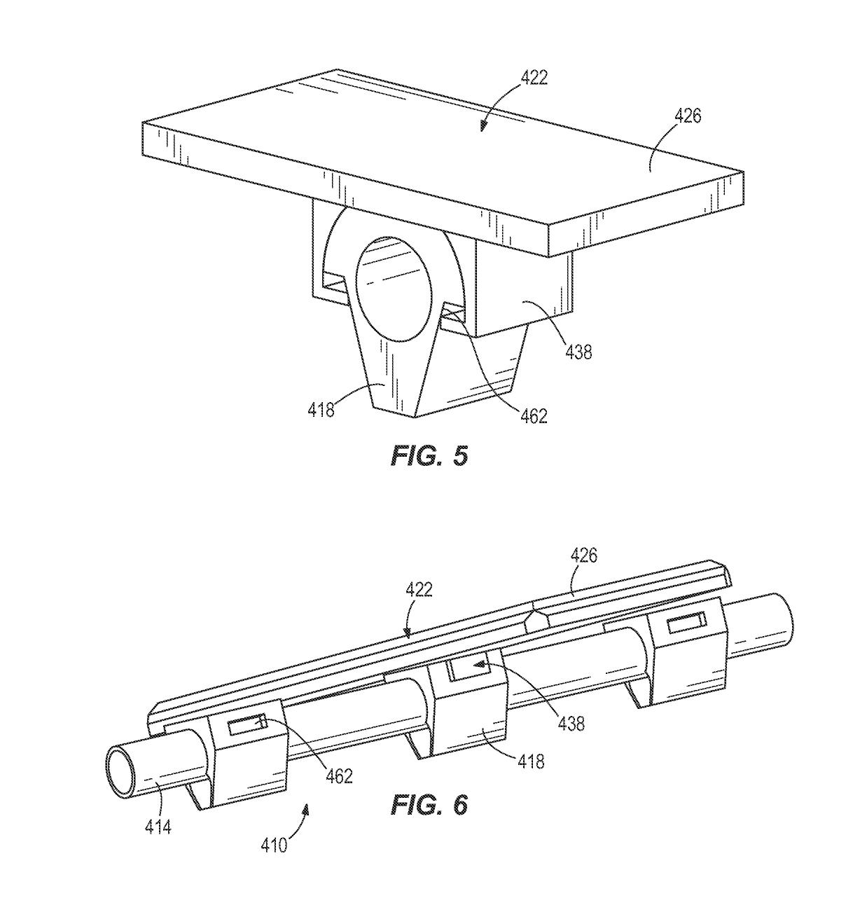

FIGS. 4a-e show a conveyor chain 310 wherein the top plate 326 is substantially the same as shown in FIGS. 3a-e, but wherein the cord coupler 318 defines angled apertures 354 and lower paddles 358. The module 322 includes arms 338 that extend from the top plate 326 but does not include a clamp or a module coupler. Instead, pins (not shown) extend through the angled apertures 354 and are secured to the apertures 342 formed in the arms 338. The angled apertures 354 allow the module 322 to rotate about the axis A while not transferring torque to the cord 314. The paddles 358 may be engaged by sprockets or other mechanisms of the conveyor system, as desired.

FIGS. 5 and 6 show a conveyor chain 410 wherein the cord 414 is a hollow tube. The cord coupler 418 defines recesses 462 that are engaged by arms 438 extending form the top plate 426 to hold the module 422 to the cord 414.

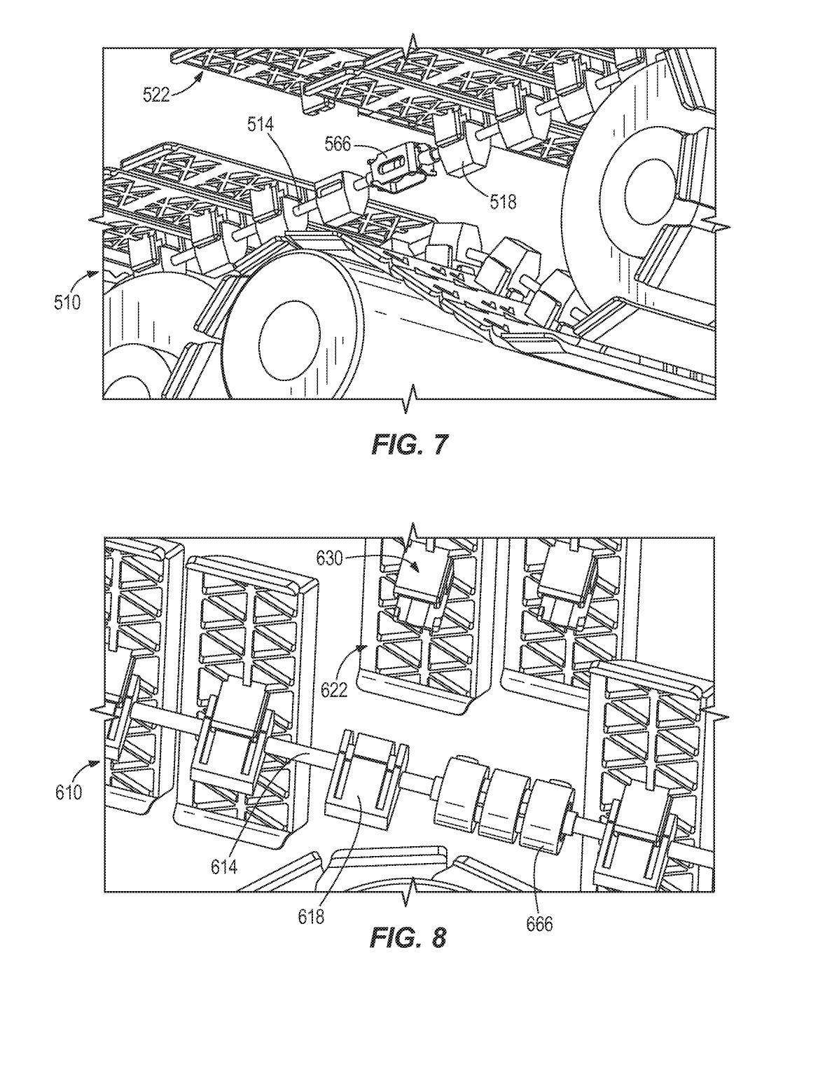

FIG. 7 shows a conveyor chain 510 that is similar to the conveyor chain 410 described above passing through a conveyor system. Also shown in FIG. 7 is one embodiment of a cord joint 566 that joins two loose ends of the cord 514 into a continuous loop.

FIG. 8 shows a conveyor chain 610 wherein the recess 662 is formed in a more vertical arrangement (as viewed in FIG. 8) that the recesses shown in FIGS. 5-7. Additionally, the cord joint 666 is arranged differently than the joint 566 to accommodate the module coupler 530 arranged to engage the vertical recesses 666.

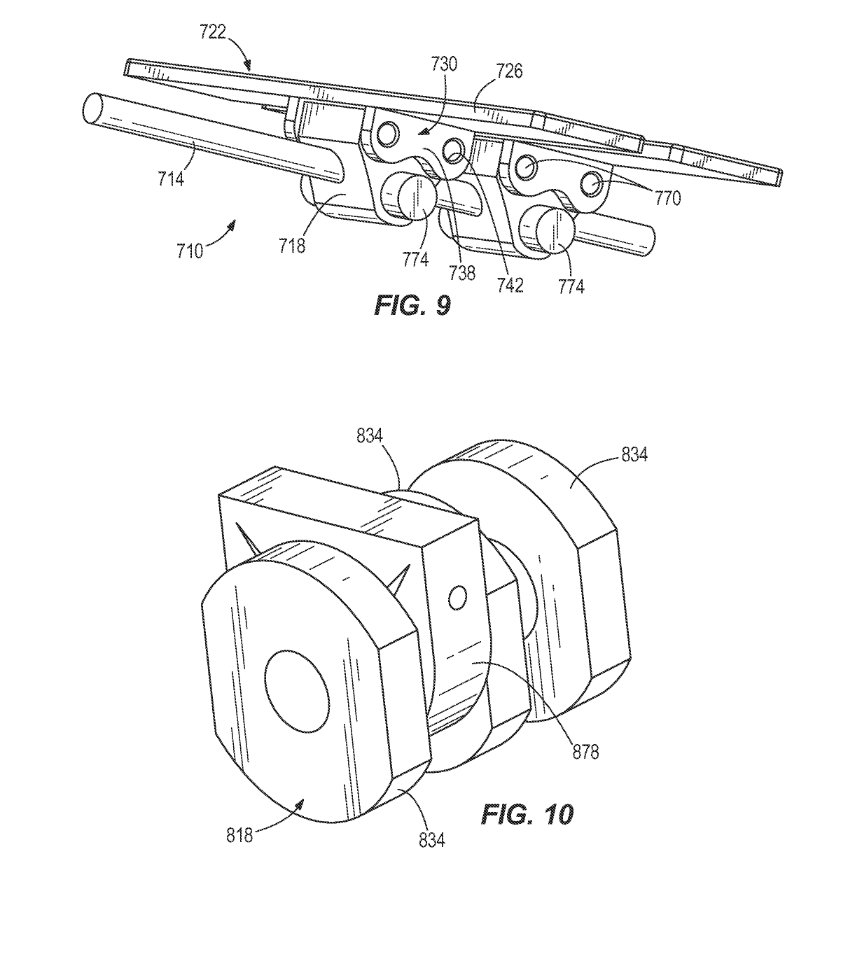

FIG. 9 shows a conveyor chain 710 wherein the cord coupler 718 defines projections 770 arranged to engage the apertures 742 formed in the arms 738, and further defines guides 774.

FIG. 10 shows a cord coupler 818 (with the cord 814 and the top plate 826 removed for clarity) that defines three toriodal projections 834, and a transverse projection 878 extending from the top plate 726 and arranged to be received between the toroidal projections 834 and engage the cord (not shown).

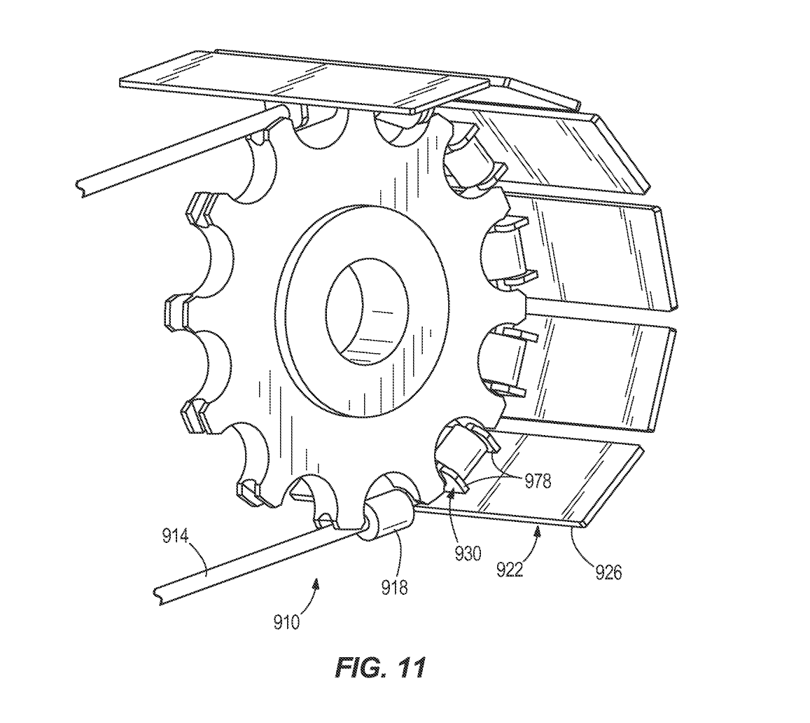

FIG. 11 shows a conveyor chain 910 mounted in a conveyor assembly. The cord coupler 918 defines a substantially cylindrical shape, and the transverse projections 978 are arranged to engage front and rear sides of the cord coupler 918 while grasping the cord 914.

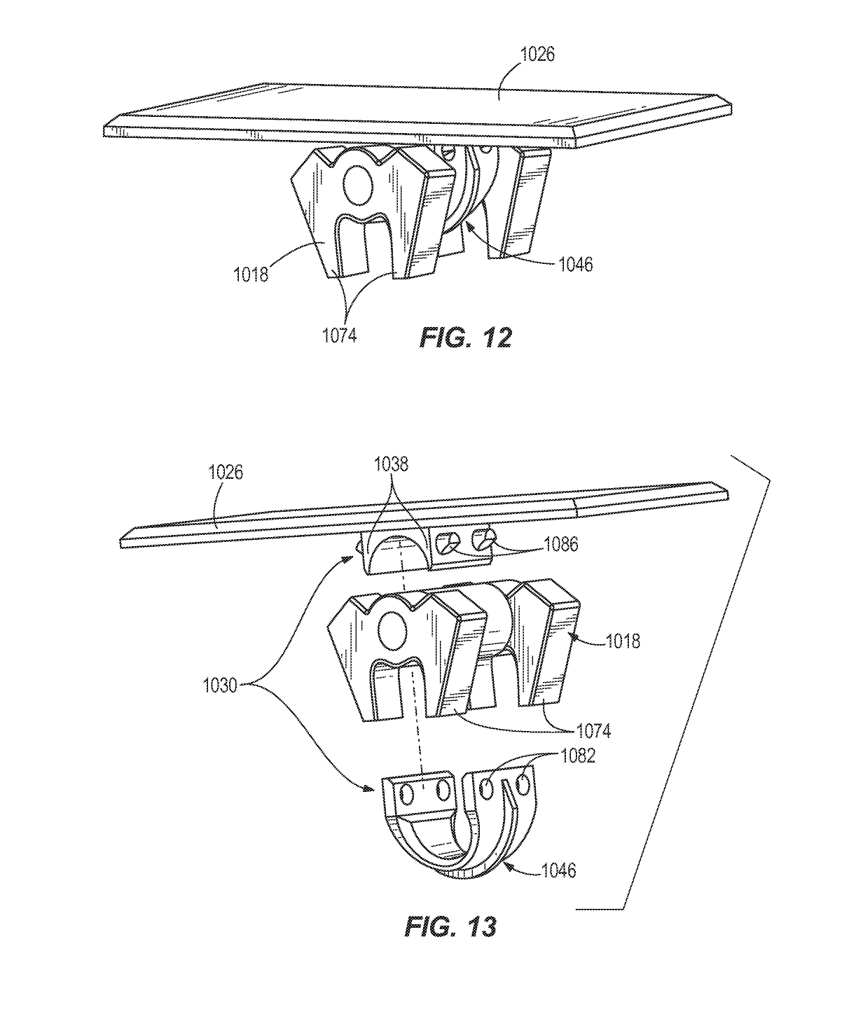

FIGS. 12 and 13 show a conveyor chain 1010 (with the cord 1014 removed for clarity) wherein the module coupler 1030 includes a clamp 1046 that defines apertures 1082 sized to engage projections 1086 formed on the arms 1038. The cord coupler 1018 includes guides 1074 arranged to aid the conveyor chain 1010 as it moves along the conveyor assembly. The clamp 1046 is configured to engage the cord coupler 1018 between the guides 1074.

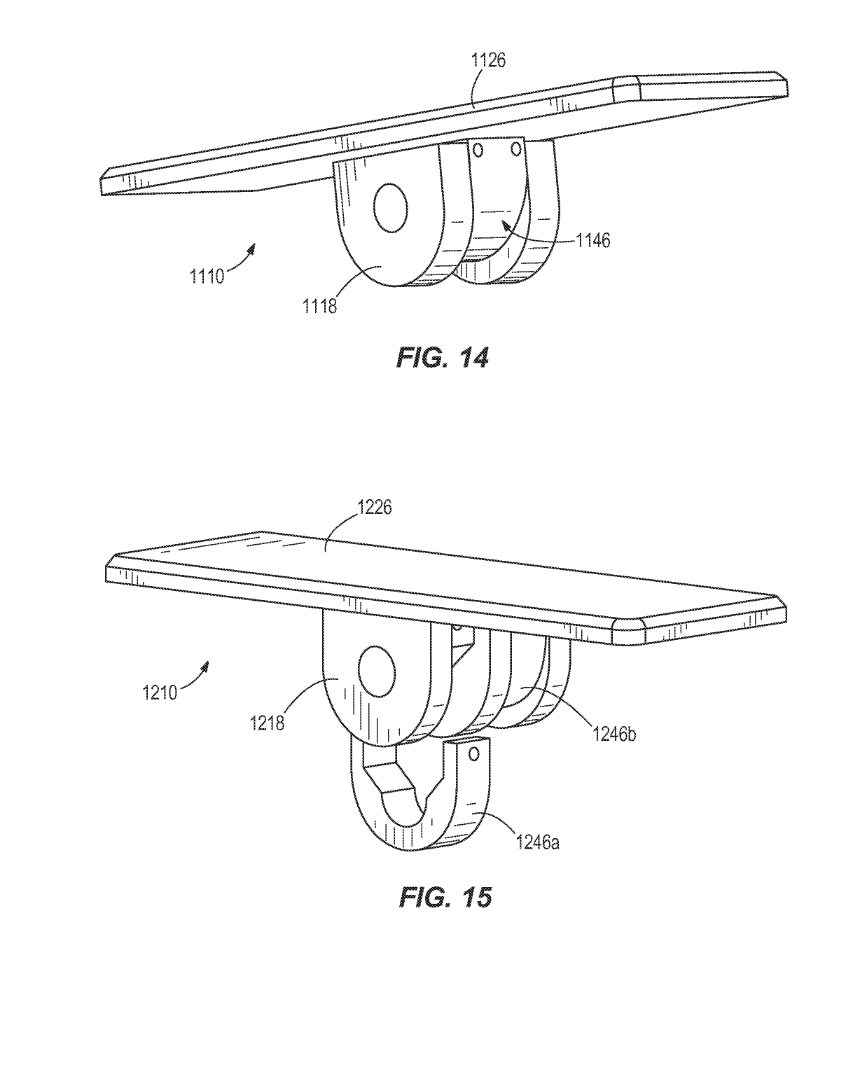

FIG. 14 shows a conveyor chain 1110 (with the cord 1114 removed for clarity) that is similar to the conveyor chain 1010 shown in FIGS. 12 and 13 wherein the cord coupler 1118 does not include guides.

FIG. 15 shows a conveyor chain 1210 (with the cord 1214 removed for clarity) that is similar to the conveyor chain 1110 shown in FIG. 14 wherein the module coupler 1230 includes two clamps 1246a and 1246b.

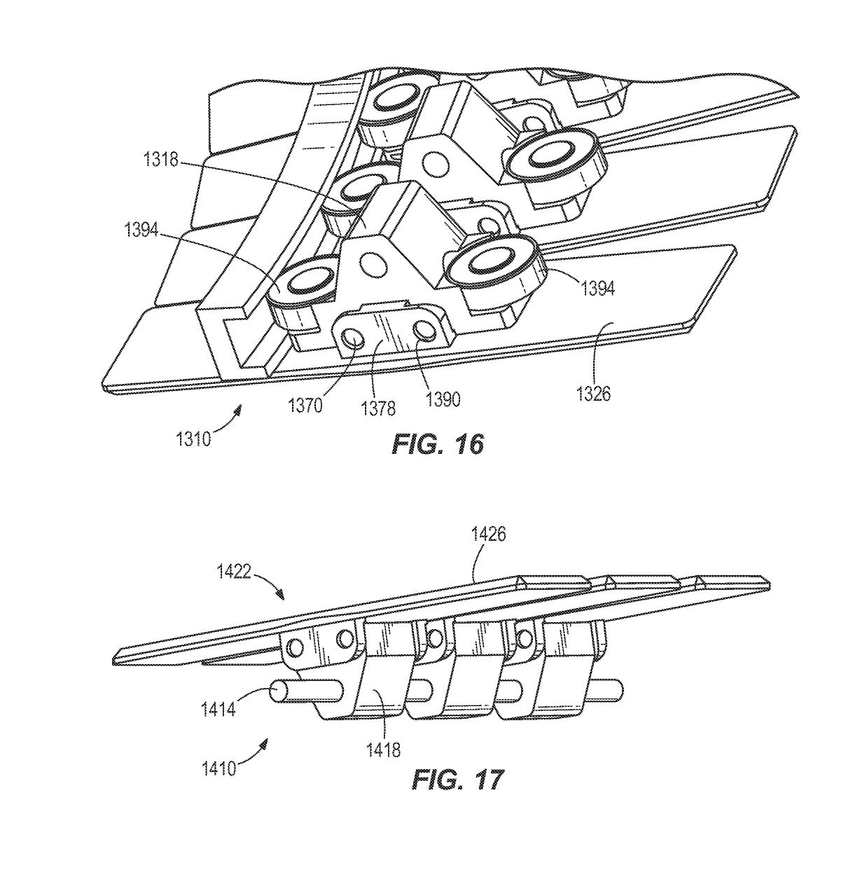

FIG. 16 shows a conveyor chain 1310 (with the cord 1314 removed for clarity) wherein the transverse plate 1378 includes apertures 1390 arranged to receive projections 1370 formed on the cord coupler 1318. Side rollers 1394 are rotatably mounted to the cord coupler 1318 and positioned to engage a guide rail of the conveyor system. This embodiment demonstrates how the inventive system provides side-flexing advantages over current conveyor chain systems.

FIG. 17 shows a conveyer chain 1410 similar to the conveyor chain 1310 shown in FIG. 16 wherein the side rollers 1394 are eliminated.

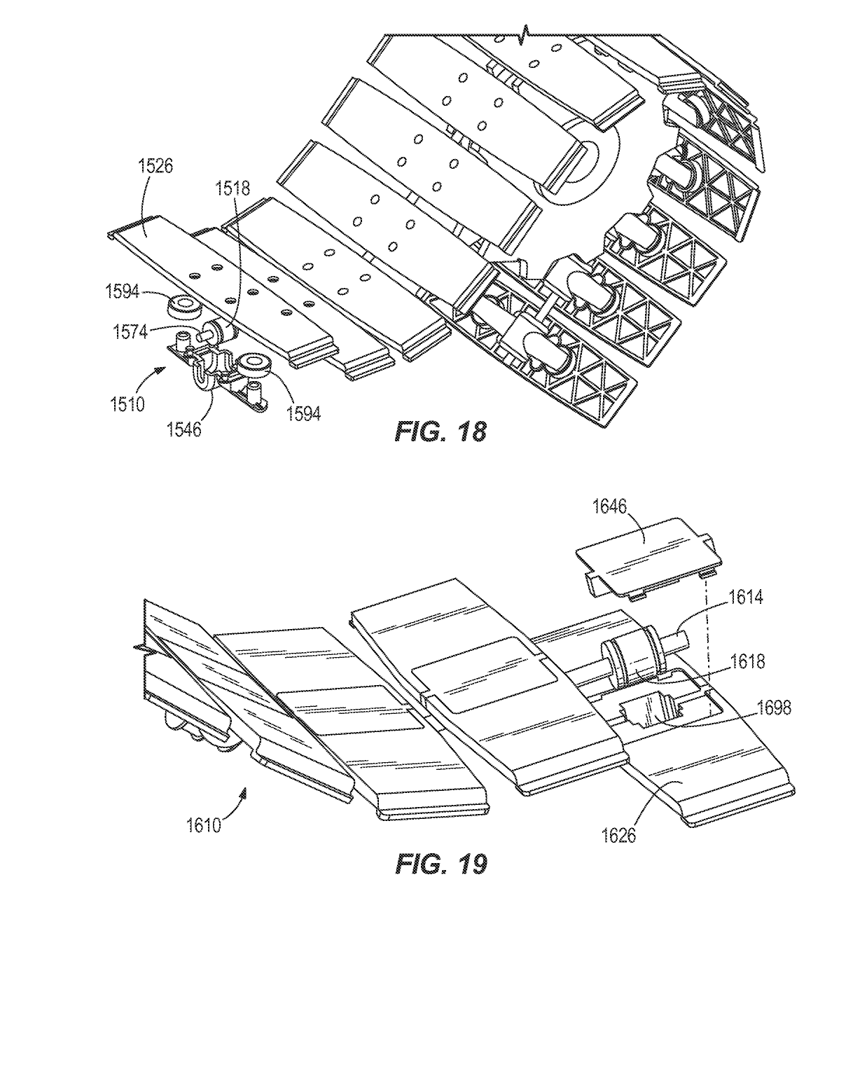

FIG. 18 shows a conveyor chain 1510 that includes a clamp 1546 arranged to capture the cord coupler 1518, two side rollers 1594, and directly engage the top plate 1526 to secure the module 1522 to the cord 1514.

FIG. 19 shows a conveyor chain 1610 wherein the cord coupler 1618 is received in a cavity 1698 recessed into the top plate 1626. The clamp 1646 covers the cavity 1698 and locks the cord coupler 1618 in place.

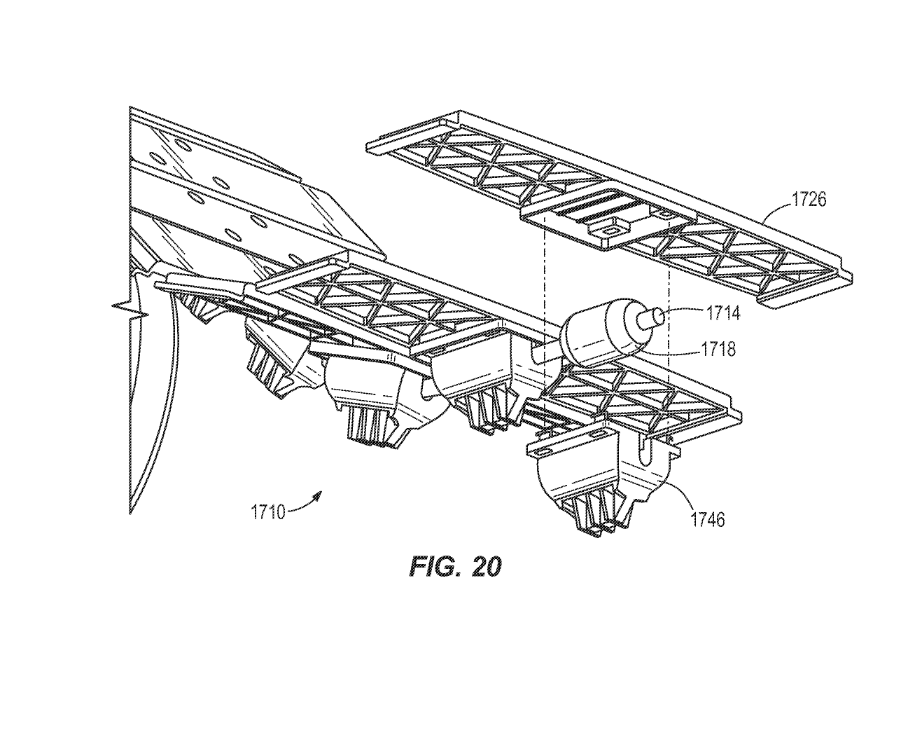

FIG. 20 shows a conveyor chain 1710 wherein the clamp 1746 directly engages a bottom side of the top plate 1726 and secures the module to the cord coupler 1718.

While there has been shown and described what are at present considered the preferred embodiments of the invention, it will be obvious to those skilled in the art that various changes and modifications can be made therein without departing from the scope of the invention defined by the appended claims. For example, the individual features described in the drawings may include one or more features from another embodiment.

We claim:

1. A conveyor chain comprising:
a continuous cord arranged to be driven and to bear a load applied to the conveyor chain;
a cord coupler secured to the cord; and
a module including a top plate engaged to the cord coupler such that the module is secured to the cord.

2. The conveyor chain of claim 1, wherein the cord is formed of wire.

3. The conveyor chain of claim 1, wherein the cord is formed of synthetic rope.

4. The conveyor chain of claim 1, wherein the cord coupler is formed with the cord.

5. The conveyor chain of claim 1, wherein the cord coupler is molded to the cord.

6. The conveyor chain of claim 1, wherein the cord coupler is fastened to the cord.

7. The conveyor chain of claim 1, wherein the cord coupler is entwined with the cord.

8. The conveyor chain of claim 1, wherein the top plate is arranged to support an object for conveyance.

9. The conveyor chain of claim 1, further comprising a module coupler for coupling the top plate to the cord coupler, the module coupler includes an aperture,
wherein the cord coupler includes a projection received within the aperture.

10. The conveyor chain of claim 1, further comprising a module coupler for coupling the top plate to the cord coupler, the module coupler includes a projection,
wherein the cord coupler includes an aperture sized to receive the projection.

11. The conveyor chain of claim 1, further comprising a module coupler for coupling the top plate to the cord coupler, the module coupler includes a clamp arranged to engage the cord coupler.

12. The conveyor chain of claim 1, further comprising a module coupler for coupling the top plate to the cord coupler, the module coupler include side rollers.

13. The conveyor chain of claim 1, wherein the cord coupler includes side rollers.

14. The conveyor chain of claim 1, wherein the module is arranged to rotate about the cord without applying substantial torque to the cord.

15. The conveyor chain of claim 1, wherein the cord coupler includes a guide.

16. The conveyor chain of claim 1, further comprising a module coupler for coupling the top plate to the cord coupler, the module coupler includes a guide.

17. The conveyor chain of claim 1, further comprising a module coupler for coupling the top plate to the cord coupler, the module coupler substantially surrounds the cord coupler.

18. The conveyor chain of claim 1, wherein the module bears no load of conveyance.

19. The conveyor chain of claim 1, further comprising a second module.

20. The conveyor chain of claim 19, wherein only the cord couples the module to the second module.
